(19) United States
(12) Patent Application Publication
(10) Pub. No.: US 2019/0297790 A1
(43) Pub. Date: Oct. 3, 2019

(54) Rat/squirrel barrier

(71) Applicants: Chih-Yu Hsia, Arcadia, CA (US); Michael Jonathan Hsia, Pasadena, CA (US); Patricia Shirley Hsia, Pasadena, CA (US)

(72) Inventors: Chih-Yu Hsia, Arcadia, CA (US); Michael Jonathan Hsia, Pasadena, CA (US); Patricia Shirley Hsia, Pasadena, CA (US)

(21) Appl. No.: 15/938,419

(22) Filed: Mar. 28, 2018

(51) Int. Cl. A01G 13/10; A01M 29/30

(52) U.S. Cl. CPC A01G 13/10; A01G 22/05; A01M 29/30

(57) ABSTRACT

A rat/squirrel barrier which consists of a row of rods which extrude from a strip that is bendable to form a loop to be mounted on a tree branch so that the row of rods fan outwards from the loop to form a barrier; the strip having many generally “V” or “U”-shaped notches to facilitate the bendability of the strip; the strip having a step-up section beyond the row of rods; the strip and its step-up section having many studs and/or holes which when being put together can engage each other to enable the joining of two or more of the strips or the loop; the strip optionally having a longitudinal depressed area.

### CROSS-REFERENCE TO RELATED APPLICATIONS

Not Applicable.

### BACKGROUND OF THE INVENTION

This invention relates to means to prevent rats or squirrels from traveling along a tree branch or a rod to unwelcome areas.

### BRIEF SUMMARY OF THE INVENTION

Rats or squirrels stealing fruits from trees have been a issue for fruit growers. Normally rats or squirrels approach fruits by climbing along tree branches. If the pathways on the tree branches can be stopped, then the snapping fruits off a fruit tree by rats or squirrels can be stopped. Additionally, rodents may climb poles and posts to travel from location to location. Reduction in this travel will result in reduction of spread of unwanted vermin. Therefore, means to stop the pathways have been sought.

The current invention provides a device which can be strategically affixed on a tree branch, trunk, or other type of rod or post. This device will create a fence-like barrier which fans outwards from the surface of the tree branch, trunk, or rod or post. The fence-like barrier will prevent rats from travelling around it. The fence-like barrier will be flexible and slippery enough to not allow rats or squirrels to climb over it. The lengths of the invented device can be easily altered for mounting on objects of different diameters.

These and other objects and advantages of the invention, as well as the details of illustrative embodiments, will be more fully understood from the following specification and drawings, in which:

### BRIEF DESCRIPTIONS OF THE SEVERAL VIEWS OF THE DRAWINGS

FIG. 1 is an isometric view of a single unit of the invented device.

FIG. 2 is an isometric view of two single units of the invented device joined together. The joining of the two single units increases the length of the invented device.

FIG. 3 is an isometric view which illustrates the use of the invented device. The central large cylinder represents the device to be prevented from climbing. The fence-like barrier is fanned out from the device.

FIG. 4 is an isometric view of a variation of the invented device.

FIG. 5 is an isometric view of the second variation of the invented device.

FIG. 6 is an isometric view of the third variation of the invented, device.

FIG. 7 is an isometric view of the fourth variation of the invented device.

FIG. 8 is an isometric view of the fifth variation of the invented device.

FIG. 9 is an isometric view of the sixth variation of the invented device.

FIG. 10 is an isometric view of a variation of a component which can be conjunctively used with the variation shown in FIG. 7.

FIG. 11 is an isometric view of another variation of a component which can be conjunctively used with the variation shown in FIG. 7.

FIG. 12 is an isometric view of a variation of a component which can be conjunctively used with the variation shown in FIG. 8 or in FIG. 9.

FIG. 13 is an isometric view of another variation of a component which can be conjunctively used with the variation shown in FIG. 8 or in FIG. 9.

FIG. 14 is an isometric view of a joined together two single units of the variation of the invented device shown in FIG. 9. The joining of the two single units is done by the variation of the component shown in FIG. 13. A second variation of the component shown in FIG. 13 joins the variation of the invented device shown in FIG. 9 to provide the ability to connect to another invented device shown in FIG. 9.

FIG. 15 is an isometric view of another variation of the invented device.

### DETAILED DESCRIPTION OF THE INVENTION

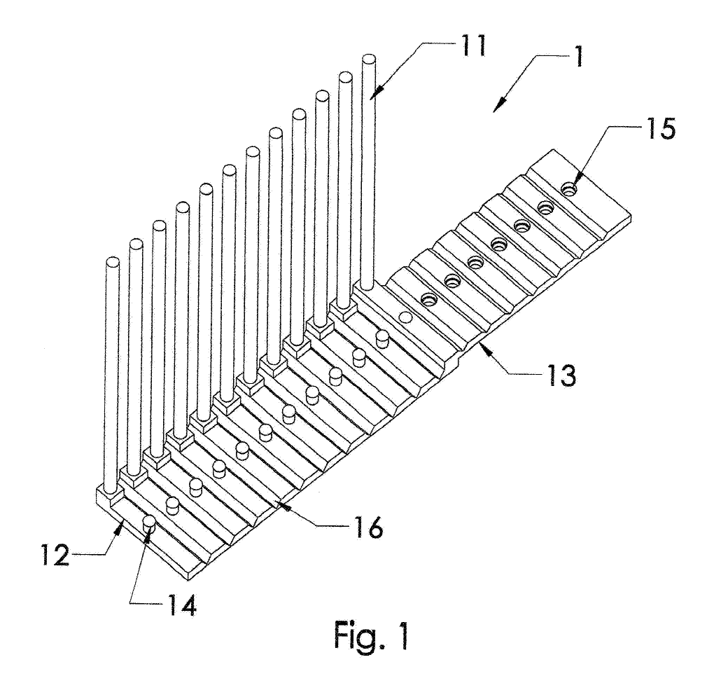

Referring to FIG. 1, the invented rat/squirrel barrier 1 consists of a row of rods, the barrier rods 11, extruding from a strip, the base strip 12. At the end of the barrier rods 11, the base strip 12 shifts up a step to form a step-up strip 13. A row of studs, the joining studs 14, extrudes from the base strip alongside of each of the barrier rods. A row of holes, the joining holes 15, is on the step-up strip. The spacing of the joining holes is the same as those of the joining studs. Many generally “V” or “U”-shaped notches, the bending notch 16, transversely along the base strip and along the step-up strip. A bending notch is between two joining holes, a joining hole and a joining stud, or two joining studs. A joining hole can be engaged with a joining stud when they are put together.

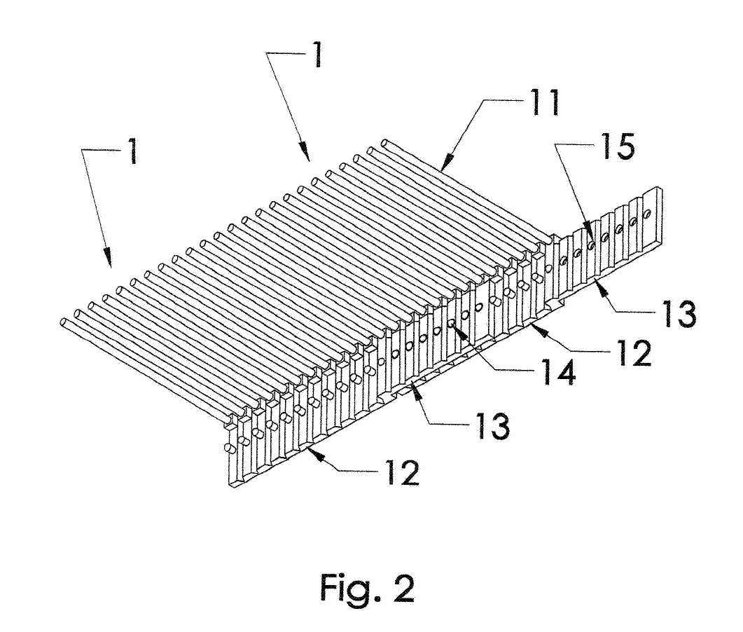

Two or more of the invented devices can be joined together to increase the length of effectiveness and numbers of the barrier rods. This will increase the length of the invented device so it can be mounted on objects of different diameters. Referring to FIG. 2, two invented devices are joined together by firstly putting the step-up strip 13 of one invented device 11 above the base strip 12 of the other invented device, then by pushing the joining studs 14 into the corresponding joining holes 15. Generally, a joining stud has an enlarged free end. A joining hole normally consists of two concentric circles, one smaller through hole and one larger depression. To engage them the enlarged free end of a joining stud will be squeezed through the smaller through hole of a joining hole but will be rested in the larger depression of the joining hole. The engagements of the joining studs and the joining holes will hold the two invented devices together. To shorten the invented device, the user simply trims off the unwanted barrier rods and their associated base strip.

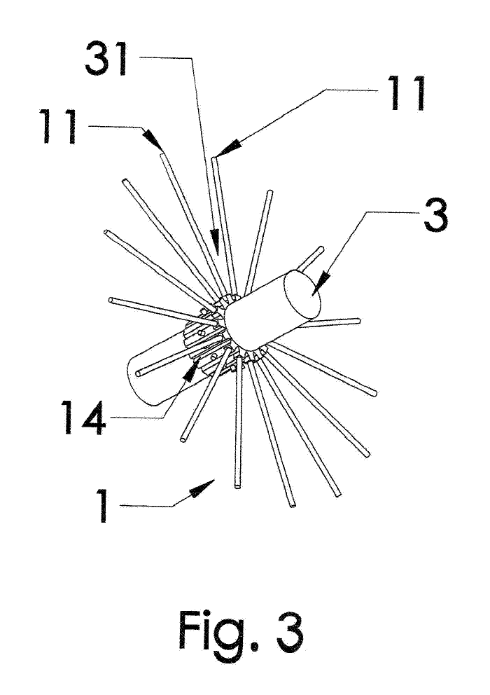

To use the invented rat/squirrel barrier, firstly the user has to ensure the invented device to have a suitable length. Referring to FIG. 3, the user will then curve the invented rat/squirrel barrier 1 around a selected object 3. The bending notch 14 will enable the device to be bent easily. Then the user puts the unattached step-up strip (not shown) above the base strip to make a complete circle around the object. Then the user pushes to engage the joining studs and the joining holes; just like joining two invented devices as described in the last paragraph. The stiffness of the base strip will keep the barrier rods fan outwards of the object.

Referring to FIG. 3, the gaps 31 between the barrier rods 11 near the object 3 will be sufficiently small that the rat/squirrel cannot squeeze through them. The flexibility to and the smoothness of the barrier rods will not provide any holding point for the rat/squirrel to hang onto. Therefore, the rat/squirrel cannot climb over the barrier. These invented rat/squirrel barriers can keep rats/squirrels from access to unwanted areas.

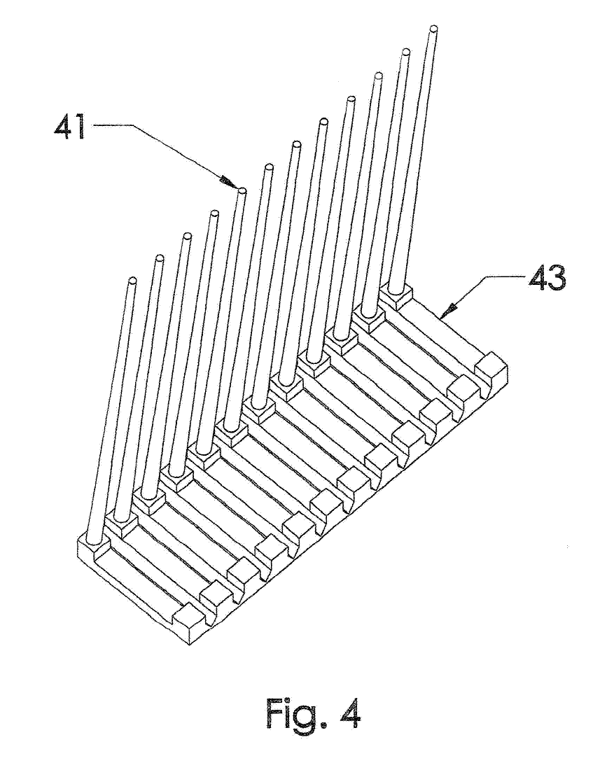

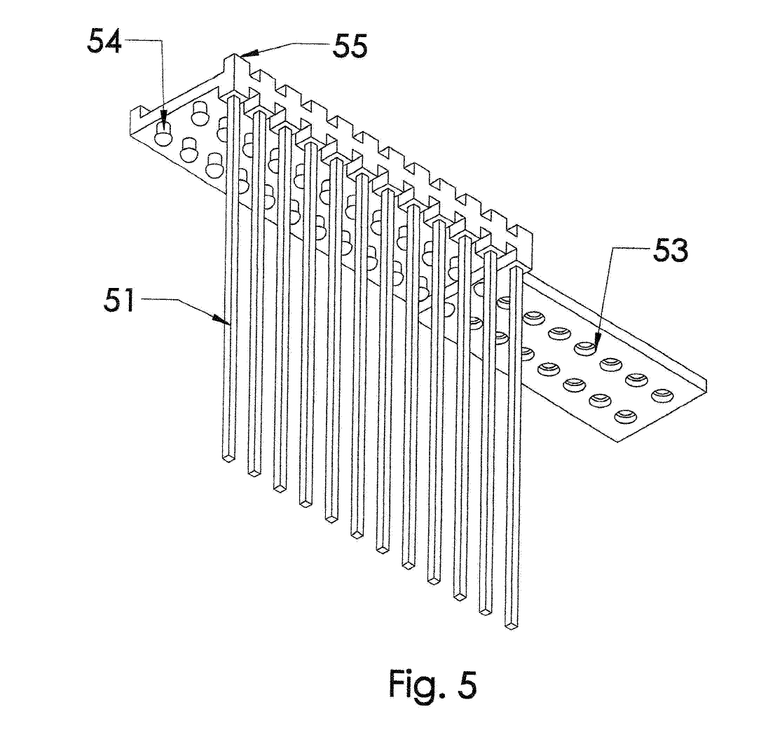

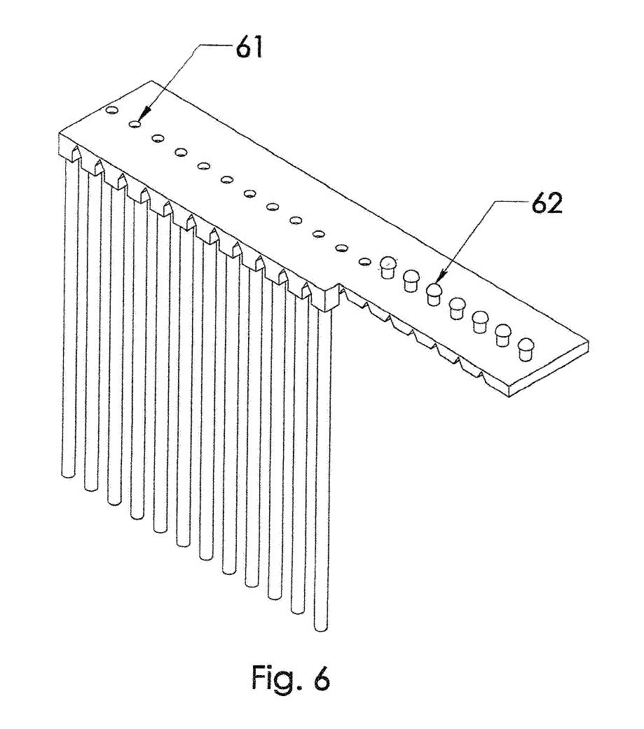

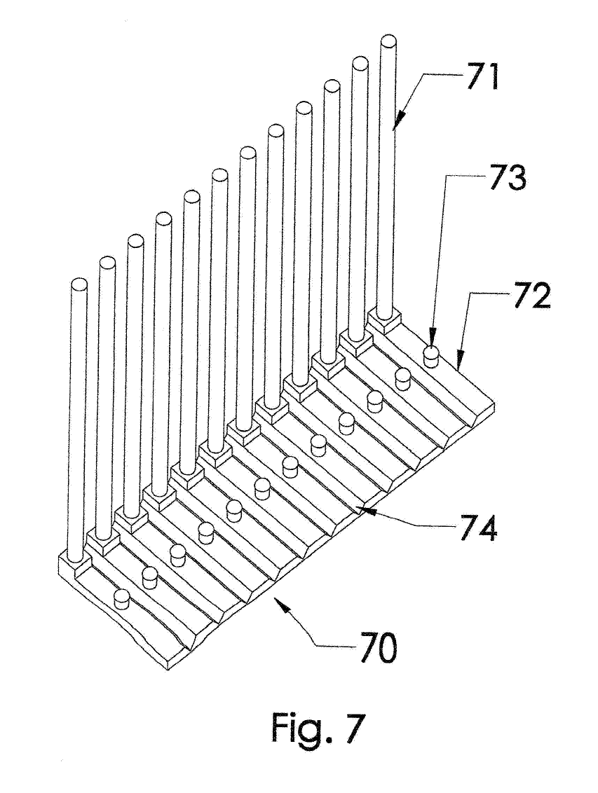

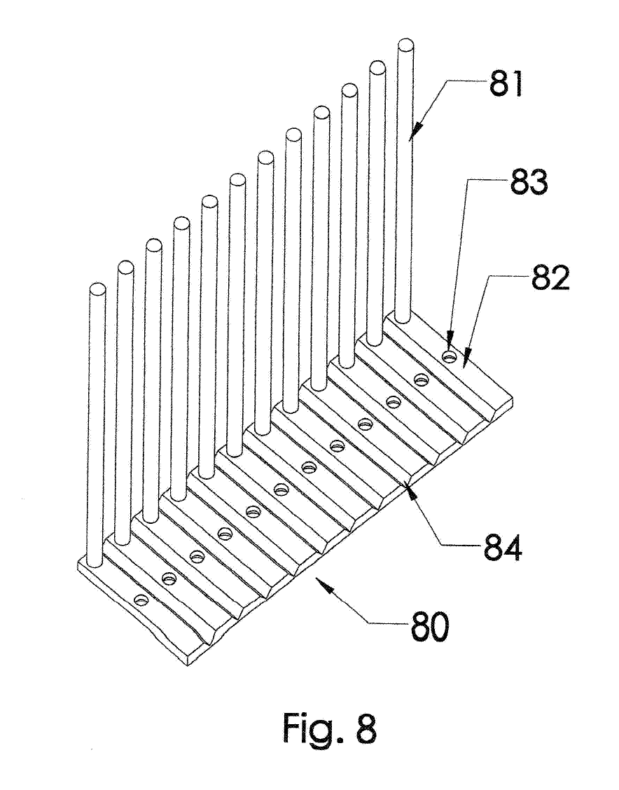

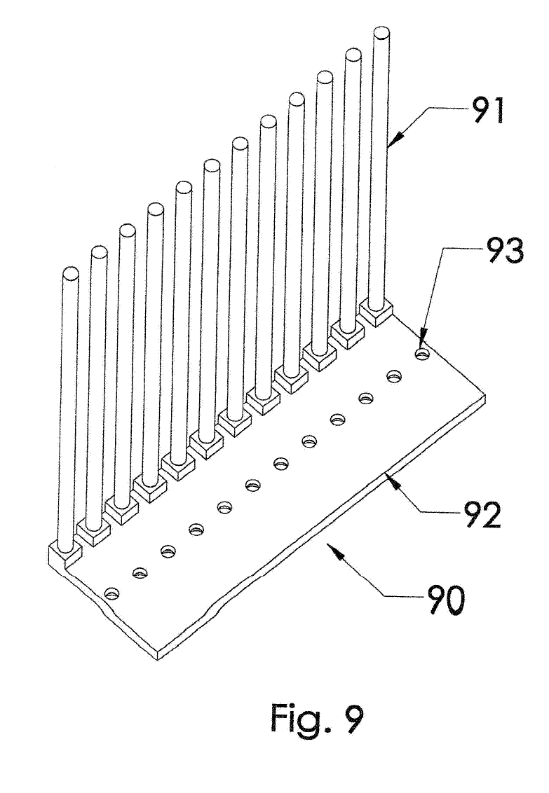

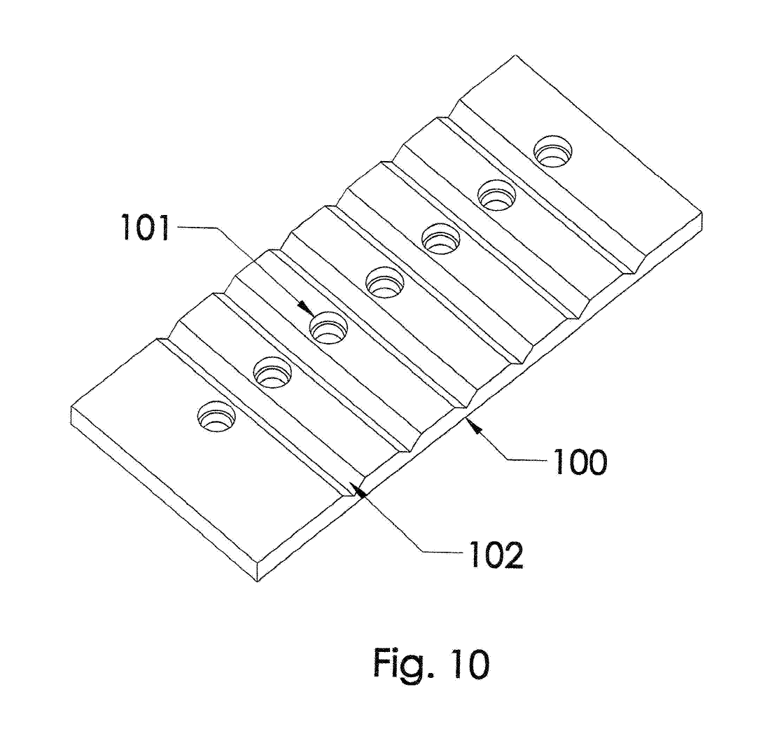

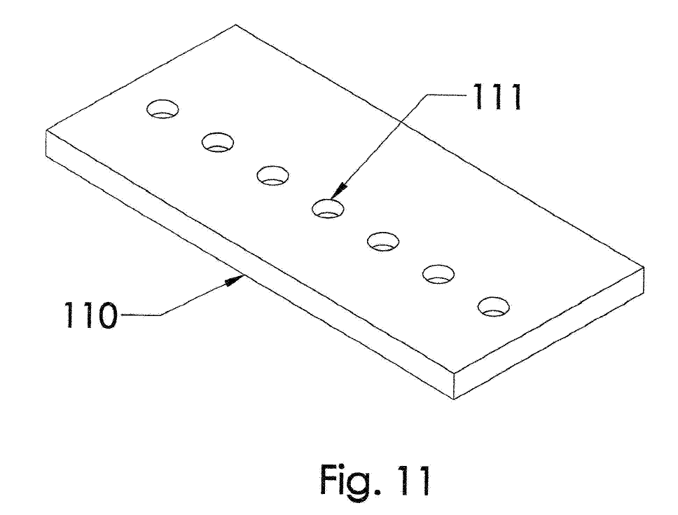

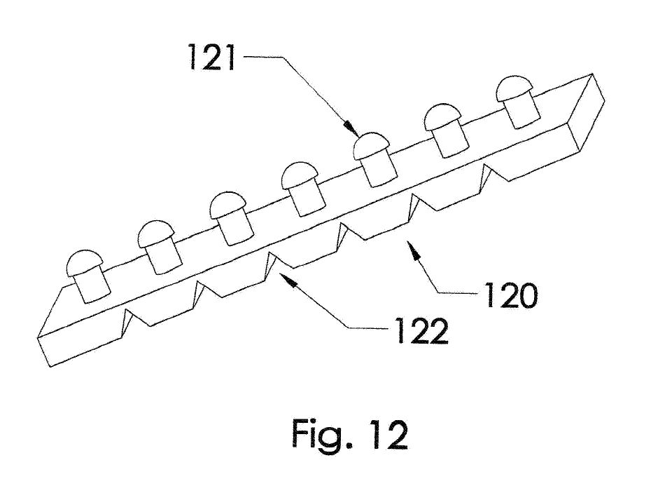

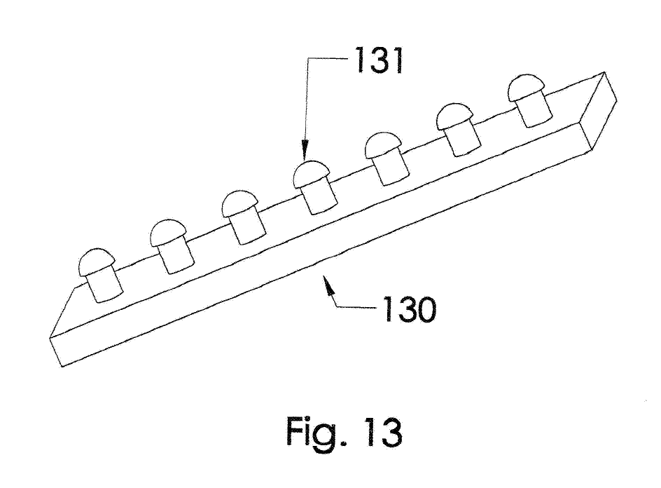

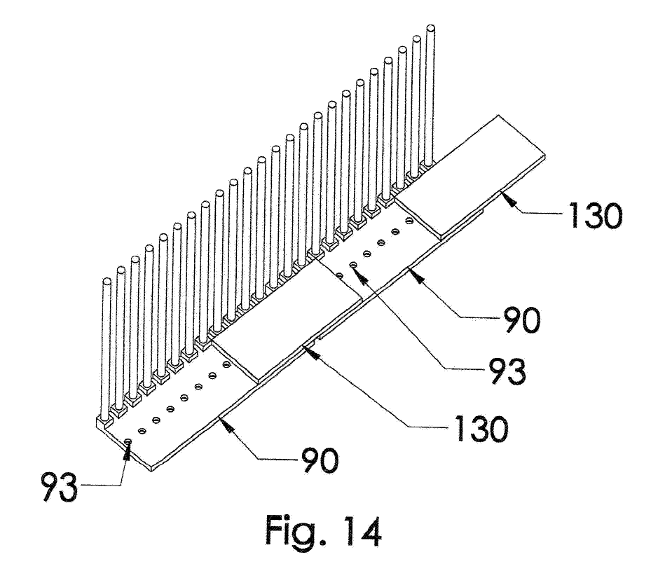

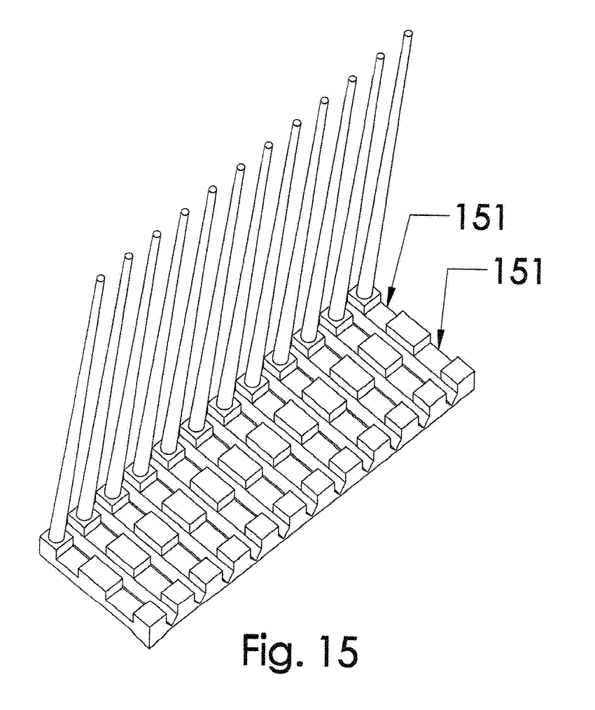

There are many variations of the invented device. For examples, the barrier rods can be tapered (referring to 41, FIG. 4) or non-circular cross-section (referring to 51, FIG. 5). The base strip can have no joining holes or the step-up strip but a depressed area or multiple depressed areas longitudinally (referring to 43, FIG. 4 and 151, FIG. 15, respectively) when the rat/squirrel barrier is meant to be tied up onto the tree branch with one or more cable tie (not shown) or equivalent. The base strip may have no bending notches if the base strip is made of a thin and/or flexible material. The base strip and the step-up strip can have more than one row of the joining holes and/or the joining studs (referring to 53 and 54, respectively FIG. 5). There can be extruding objects, the anchoring key 55, FIG. 5, on the base strip at the opposite side of the barrier rods. The anchoring key will keep the rat/squirrel barrier at the same location of the tree branch. The base strip can have the joining holes (referring to 61, FIG. 6) instead of the joining studs. Likewise, the step-up strip can have the joining studs (referring to 62, FIG. 6) instead of the joining holes. The invented rat/squirrel barriers (referring to 70, 80 and 90 in FIG. 7, FIG. 8 and FIG. 9, respectively) can have a row of the barrier rods (referring to 71, 81, and 91 in FIG. 7, FIG. 8 and FIG. 9, respectively) and a base strip (referring to 72, 82, and 92 in FIG. 7, FIG. 8 and FIG. 9, respectively). Many joining studs and bending notches (referring to 73 and 74, respectively, in FIG. 7) or many joining holes and bending notches (referring to 83 and 84, respectively in FIG. 8) can optionally on the base strip. The base strip can optionally have only joining holes (93, FIG. 9) but no bending notch as shown in FIG. 9. Referring to FIG. 10, the joining strip 100 is a strip of material which has many joining holes 101 and bending notches 102. Referring to FIG. 11, the joining strip 110 is a strip of material which has many joining holes 111 but without bending notches. Referring to FIG. 12, the joining strip 120 is a strip of material which has many joining studs 121 and bending notches 122. Referring to FIG. 13, the joining strip 130 is a strip of material which has many joining studs 131. The shapes and spacing of the joining holes, joining studs and the bending notches of the joining strips are the same as those devices described in FIG. 7, FIG. 8 or FIG. 9. FIG. 14 illustrates the joining of the devices shown in FIG. 9 and FIG. 13. Referring to FIG. 14, two invented rat/squirrel barriers 90 are placed together. Then a joining strip 130 is placed on the rat/squirrel barriers. Then the joining studs (not shown) of the joining strip are pushed into the joining holes 93 to lock the two invented rat/squirrel barriers 90 together. Likewise, a joining strip 130 can be placed and locked on a rate/squirrel barrier 90 firstly (as shown on the right side of FIG. 14) so it can be used to join other invented devices. The joining strips shown in FIG. 10 and FIG. 11 can join devices shown in FIG. 7. The joining strips shown in FIG. 12 and FIG. 13 can join devices shown in FIG. 8 and/or FIG. 9.

The foregoing is considered as illustrative only of the principles of the invention. Furthermore, since numerous modifications and changes will readily occur to those skilled in the art, it is not desired to limit the invention to the exact construction and operation shown and described, and accordingly all suitable modifications and equivalents, may be resorted to, falling, within the scope of the invention as claimed.

We claim:

1. A rat/squirrel barrier which consists of a row of rods which extrude from a strip that is bendable to form a loop so that said row of rods can fan outwards from said loop; said strip having a section beyond said row of rods; said strip having a stud in plural faun and a hole in plural form; when being put together, said stud being able to engage with said hole.

2. A rat/squirrel barrier of claim 1 which said strip has a generally “V” or “U”-shaped notch in plural faun transversely to facilitate the bendability of said strip.

3. A rat/squirrel barrier of claim 1 which said strip beyond said row of rods becomes a step-up section; said strip having a hole in plural form and/or a stud in plural form; said step-up section having a stud in plural form and/or a hole in plural form; when being put together, said stud being able to engage with said hole.

4. A rat/squirrel barrier of claim 1 which said strip has an extruding object in plural form on its back side, which is the opposite side of said row of rods.

5. A rat/squirrel barrier of claim 3 which said strip has an extruding object in plural form on its back side, which is the opposite side of said row of rods.

6. A rat/squirrel barrier of claim 3 which said strip has a generally “V” or “U”-shaped notch in plural form transversely.

7. A rat/squirrel barrier of claim 3 which said strip and said step-up section have a generally “V” or “U”-shaped notch in plural form transversely.

8. A rat/squirrel barrier of claim 3 which said step-up section has a generally “V” or “U”-shaped notch in plural form transversely to facilitate the bendability of said step-up section.

9. A rat/squirrel barrier of claim 5 which said strip has a generally “V” or “U”-shaped notch in plural form transversely.

10. A rat/squirrel barrier of claim 5 which said strip and said step-up section have a generally “V” or “U”-shaped notch in plural form transversely.

11. A rat/squirrel barrier of claim 5 which said step-up section has a generally “V” or “U”-shaped notch in plural form transversely to facilitate the bendability of said step-up section.

12. A rat/squirrel bander which consists of a row of rods which extrude from a strip which has a stud in plural form and/or a hole in plural form; said strip being able to engage with another strip which has a hole in plural form and/or a stud in plural form.

13. A rat/squirrel barrier of claim 12 which said strip has a generally “V” or “U”-shaped notch in plural form transversely.

14. A rat/squirrel barrier of claim 12 which said another strip has a generally “V” or “U”-shaped notch in plural form transversely.

15. A rat/squirrel barrier which consists of a row of rods which extrude from a strip which is bendable to form a loop so that said row of rods can fan outwards from said loop; said strip longitudinally having a depressed area and/or a depressed area in plural form.

16. A rat/squirrel barrier of claim 15 which said strip has an extruding object in plural form on its back side which is the opposite side of said row of rods.

17. A rat/squirrel barrier of claim 15 which said strip has a generally “V” or “U”-shaped notch in plural form transversely.

18. A rat/squirrel barrier of claim 16 which said strip has a generally “V” or “U”-shaped notch in plural form transversely.
